(19) United States
(12) Patent Application Publication
(10) Pub. No.: US 2015/0082188 A1
(43) Pub. Date: Mar. 19, 2015

(54) MESSAGING INTERACTION ENGINE

(71) Applicants: Allen Lau, Oakland, CA (US); Gabriel Thendean, Pleasanton, CA (US); Mark White, Basingstoke (GB)

(72) Inventors: Allen Lau, Oakland, CA (US); Gabriel Thendean, Pleasanton, CA (US); Mark White, Basingstoke (GB)

(21) Appl. No.: 14/026,987

(22) Filed: Sep. 13, 2013

(51) Int. Cl. H04L 12/58

(52) U.S. Cl. CPC H04L 51/26
USPC 715/752

(57) ABSTRACT

Disclosed herein are system, method, and computer program product embodiments for managing message interactions. An embodiment operates by receiving, by a message interaction device, a message, determining a current state of a message interaction engine associated with the message, determining a value of a dynamic parameter associated with the current state, selecting an action based on the current state, the message, and the dynamic parameter, and performing the action.

### BACKGROUND

### Background

A communication session between communication devices may include multiple message interactions. Each message interaction includes at least an initial message and a message or action in response to the initial message. The possible responses/actions triggered by the initial message may vary significantly from one message interaction to another. In some cases, these responses/actions may be complex and computationally-expensive, and thus, may overwhelm the processing capabilities of some devices. Thus, proper management of these interactions helps achieve a successful communication session.

### BRIEF DESCRIPTION OF THE DRAWINGS

The accompanying drawings are incorporated herein and form a part of the specification.

FIG. 1 is a block diagram of a system that includes a message interaction engine, according to an example embodiment.

FIG. 2 is a flowchart illustrating a process for managing message interactions, according to an example embodiment.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for managing message interactions between devices using a messaging interaction engine.

Advances in communication technology have paved the way for the development of complex applications. For example, a smartphone may interact with an application server to run applications such as internet browsing and commerce, satellite-based navigation, etc.

Communication between devices (e.g., mobile to mobile and mobile to server) to realize these applications may include multiple interactions, and may be performed through one or more messaging protocols such as short message service (SMS), multimedia message service (MMS), internet protocol (IP). IP multimedia subsystem (IMS), wireless application protocol (WAP), a structured or an unstructured data transfer, a data transfer operation atop one or more standards-based protocols (such as for example TCP/IP) and/or proprietary protocols, an Electronic Message (E-Mail) exchange, an Instant Messaging (IM) exchange, Wi-Fi packets, a Near Field Communication (NFC) exchange, etc. Proper management of message flows between the devices is important for efficient and timely communication between these devices.

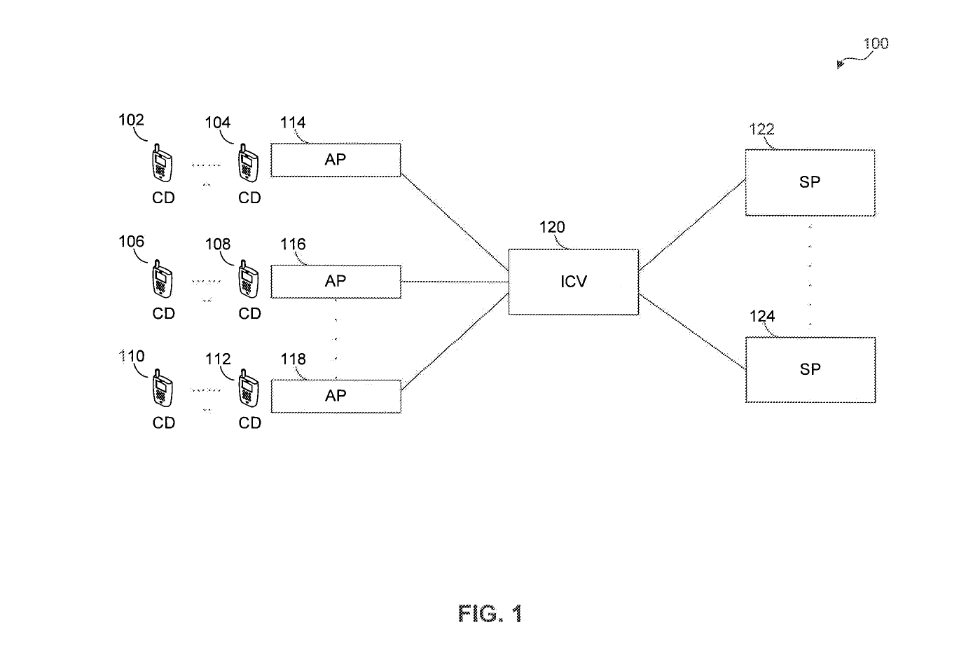

FIG. 1 is a block diagram of a communication environment 100 to illustrate certain aspects of the present disclosure. In the environment, client devices (CD) 102-112 communicate with service providers 122 and 124 through access points (AP) 114-118 and inter-carrier vendor (ICV) 120. Client devices 102-112 may also communicate among themselves through access points 114-118 and ICY 120, or may only use an access point (e.g., communication between client device 102 and client device 104 may stay within access point 114 and may not reach ICV 120).

Client devices 102-112 are illustrated as cellphones/mobile phones, however, the present disclosure is not so limited, and client devices 102-112 may include without limitation a wired device, a smartphone, a tablet computer, a laptop/mobile computer, a handheld computer, a desktop computer, a server computer, an in-vehicle device (e.g., audio, navigation, etc.), an in-appliance device, a Personal Digital Assistant (PDA), a game console, a Digital Video Recorder (DVR) or Personal Video Recorder (PVR), a cable system set-top-box, an entertainment system component such as a television set, etc.

Access points 114-118 may include a base transceiver station of a mobile phone network, an access point of a Wi-Fi network, an Ethernet hub, etc. Accordingly, in exemplary embodiments, client devices 102-112 may connect to access points 114-118 through wireless or wired means.

In an embodiment, ICV 120 is a device for forwarding messages across domains operated by different carriers. For example, client device 102 and service provider 122 communicate through ICV 120 to synchronize/harmonize information exchanged between the parties, and thus, allow service provider 122 to serve client device 102.

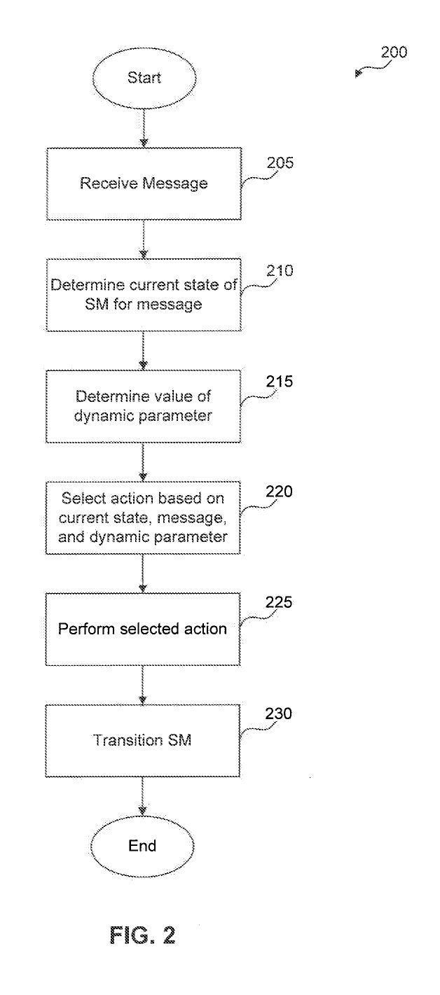

FIG. 2 is a flowchart illustrating a process for managing messaging interactions according to an embodiment. The flowchart is described with continued reference to the embodiment of FIG. 1. However, the flowchart is not limited to that embodiment.

At step 205, a message interaction engine embedded within a device, such as ICV 120, receives an SMS message from a client device, such as CD 102. A person of skill in the art would understand that a message interaction engine may be a stand-alone device including one or more processors and a memory device, or be embedded within other devices including one or more processors and a memory device. Further, a person of skill in the art would understand that the message may be of communication protocols other than SMS, such as MMS, IP, IMS, etc.

At step 210, the message interaction engine determines the current state of a message interaction engine associated with the message. Specifically, the message interaction engine parses the received SMS message to read a key value that can be cross-referenced with a list of message interaction engines located in local memory. The message interaction engine can then find aspects of the state associated with the message and use the information to determine, for example, the current state of the engine, possible actions to perform based on the message, etc.

The key value could have been previously assigned to a particular communication session by the message interaction engine or may be determined from information exchanged in the interaction, such as the address of the source, the address of the destination, or some other value that is unique to the particular interaction. A person of skill in the art would understand that the list and/or aspects of message interaction engines referenced above may be located in a remote server or database instead of a local memory.

At step 215, the message interaction engine determines the value of a dynamic parameter associated with the message interaction engine. In particular, the aspects of the message interaction engine may include the current state of the engine, the current value of a dynamic parameter associated with the engine or information on obtaining the current value of the dynamic parameter associated with the engine. The dynamic parameter may be, for example, a weight or priority associated with a possible transition of the engine, a weight or priority associated with a possible action to be performed based on the current state of the engine and the key value, a dynamic rule based on external factors, a timer, etc.

At step 220, the message interaction engine selects an action out of a plurality of possible actions based on the current state, the message, and the dynamic parameter. For example, a request message may be acted upon by forwarding the message to one of multiple servers, and the dynamic parameter may include parameters associated with each of the multiple servers, such as current workload, availability, network distance (hop distance) from the ICV 120, etc. The server to which the request is forwarded, for example, may be selected based on one or more of these dynamic parameters.

At step 225, the message interaction engine performs the selected action. The action may include sending a response message to the source of the initial message, sending a message to the destination of the initial message, sending a message to some other entity/device inside or outside the network, or a combination thereof The action may further include processing of, for example, data included in the SMS message, the dynamic parameter, or some other aspect of the message interaction engine. Such processing may include examination, augmentation, manipulation, replacement, validation, etc., of the particular data.

For example, the SMS message may include a request for providing a stock quote to a plurality of destinations. Thus, the message may include a code to signal the request for the stock quote, the name of the corresponding stock, and a name associated with a group of clients that should receive the stock quote. Upon receiving the SMS, the message interaction engine may parse the SMS for information necessary to determine a state associated with the request and may retrieve aspects of the associated state from a local memory. A person of skill in the art would understand that the aspects of message interaction engines referenced above may be located in a remote server or database instead of a local memory. Based on the current state of the engine, the message interaction engine may access a service provider to request the value of dynamic parameters such as the current value of the stock and the addresses of the clients who should receive the stock quote. The message interaction engine may then transmit to the clients an SMS including the stock quote and, because the value of the stock is dynamic, the message interaction engine may monitor and update the value of the stock as the message is sent to the clients. Accordingly, because of the dynamic nature of the stock price, a client receiving the first notification SMS may receive a stock quote that is different from that received by a client receiving the last notification SMS.

At step 230, the message interaction engine updates aspects of the message interaction state to, for example, transition the engine to a next state and stores the information in the corresponding local memory, a remote server, or database.

The description presented above with respect to FIG. 2 is for illustration only and those of skill in the art would understand that numerous alternatives (involving for example other components, different component arrangements, additional component interactions, etc.) are possible.

For example, a message interaction engine may be embodied in each of APs 114-118 and each message interaction engine may be configured to manage interactions associated with the CDs served by the corresponding AP. In addition, message interactions as those described above (e.g., between CD 102 and ICV 120) may include one or more information elements (such as for example a relevant or applicable factoid, a piece of product information, etc.), advertisements, promotional items, coupons, vouchers, surveys, questionnaires, gift cards, retailer credits, etc., which may be selected statically or randomly (from for example a repository of defined data elements), may be location-based (for example, selected from a pool of available data elements based on information about the current physical location of a user's CD), etc.

Information on the current physical location of a user's CD, as obtained through a Location-Based Service (LBS) application, may be used to enhance security, provide more timely or relevant information, or to use as a dynamic parameter as described with reference to FIG. 2. For example, information conveyed to a CD may be adapted to meet specific localization needs such as language, date and time format, etc. Such adaptations may be driven by user's preferences or other information about the current physical location, and may leverage predetermined or dynamic location-based information.

Furthermore, the repositories that were referenced above to store aspects of the message interaction engine (local memory, a remote server, or database) may include one or more of a conventional Relational Database Management Systems (RDBMSs), Object Database Management Systems (ODBMS), in-memory Database Management Systems (DBMS), equivalent data storage and management facilities, etc. Aspects of the message interaction engine may optionally reside in one or more of CD, a cloud, etc. as either a single entity or distributed among a set of entities. The universe of sources from which a message interaction engine may gather data is dynamically extensible and may comprise inter alia any combination of one or more of local and/or remote environments.

A SP may offer various reporting mechanisms including scheduled reporting (e.g., hourly, daily, weekly, etc.), on-demand reporting, scheduled data mining operations, and/or on-demand data mining operations, with results delivered through any combination of one or more of (SMS, MMS, IMS, etc.) messaging, a Web-based facility, E-Mail, data transfer operations, a Geographic Information System (GIS) or other visualization facility, etc. Such reporting mechanisms may draw from repositories within a service provider and/or any number of data sources external to a service provider.

A message interaction engine may leverage among other things delivery window rules, logic, settings, etc. that may be associated with, designated for, etc. any combination of one or more of a CD, an AP, etc. Such delivery window rules, logic, settings, etc. may define one or more times of a day, one or more days of a week, etc. during which the sending as output of a quanta of data (such as for example one or more SMS, etc. messages) should be delayed, prohibited, etc.

### Example Computer System

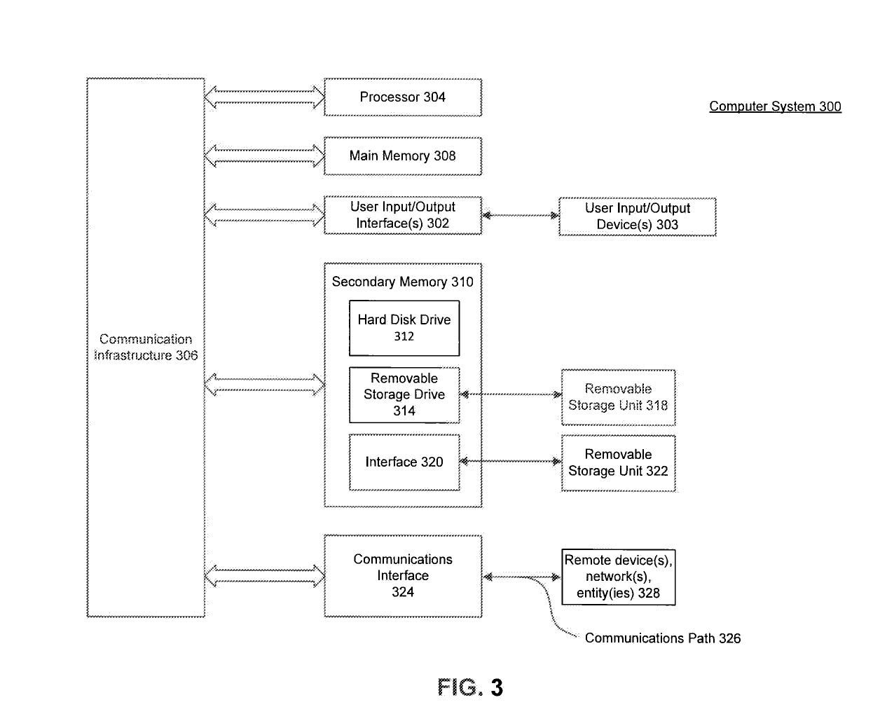

Various embodiments can be implemented, for example, using one or more well-known computer systems, such as computer system 300 shown in FIG. 3. Computer system 300 can be any well-known computer capable of performing the functions described herein, such as computers available from International Business Machines, Apple, Sun, HP, Dell, Sony, Toshiba, etc.

Computer system 300 includes one or more processors (also called central processing units, or CPUs), such as a processor 304. Processor 304 is connected to a communication infrastructure or bus 306.

One or more processors 304 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 300 also includes user input/output device(s) 303, such as monitors, keyboards, pointing devices, etc., which communicate with communication infrastructure 306 through user input/output interface(s) 302.

Computer system 300 also includes a main or primary memory 308, such as random access memory (RAM). Main memory 308 may include one or more levels of cache. Main memory 308 has stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 includes a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 reads from and/or writes to removable storage unit 318 in a well-known manner.

According to an exemplary embodiment, secondary memory 310 may include other means, instrumentalities or other approaches for allowing computer programs and/or other instructions and/or data to be accessed by computer system 300. Such means, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 enables computer system 300 to communicate and interact with any combination of remote devices, remote networks, remote entities, etc. (individually and collectively referenced by reference number 328). For example, communication interface 324 may allow computer system 300 to communicate with remote devices 328 over communications path 326, which may be wired and/or wireless, and which may include any combination of LANs, WANs, the Internet, etc. Control logic and/or data may be transmitted to and from computer system 300 via communication path 326.

In an embodiment, a tangible apparatus or article of manufacture comprising a tangible computer useable or readable medium having control logic (software) stored thereon is also referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 3. In particular, embodiments may operate with software, hardware, and/or operating system implementations other than those described herein.

### CONCLUSION

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A method comprising:
receiving, by a message interaction device, a message;
determining a current state of a message interaction engine associated with the message;
determining a value of a dynamic parameter associated with the current state;
selecting an action based on the current state, the message, and the dynamic parameter; and
performing the action.

2. The method of claim 1, the determining of the current state comprising:
parsing the message to obtain a key identifier of the message interaction engine; and
determining the message interaction state associated with the message based on the key identifier.

3. The method of claim 2, the selecting of the action comprising:
identifying a plurality of possible actions based on the current state and the message;
determining a priority for each of the possible actions based on the dynamic parameter; and
selecting the action based on the priority.

4. The method of claim 1, the performing the action comprising:
transmitting a second message to a destination identified in the message.

5. The method of claim 1, the performing the action comprising:
transmitting a dynamic information element to a plurality of destinations.

6. The method of claim 5, the transmitting of the dynamic information element to a plurality of destinations comprising:
transmitting a first value to a first destination; and
transmitting a second value that is different than the first value to a second destination based on real-time changes associated with the dynamic information element.

7. The method of claim 1, further comprising
transitioning the message interaction engine into a future state based on the message and the value of the dynamic parameter.

8. The method of claim 1, further comprising
transitioning the message interaction engine into a future state of a plurality of future states based on the message and a dynamic transition prioritization rule for the current state,
wherein the dynamic transition prioritization rule comprises selection criteria for selecting a transition based on the value of the dynamic parameter, and
wherein the value of the dynamic parameter comprises a transition timer.

9. A system, comprising:
a memory; and
at least one processor coupled to the memory and configured to:
receive a message;
determine a current state of a message interaction engine associated with the message;
determine a value of a dynamic parameter associated with the current state;
select an action based on the current state, the message, and the dynamic parameter; and
performing the action.

10. The system of claim 9, wherein to determine the current state the at least one processor is further configured to:
parse the message to obtain a key identifier of the message interaction engine; and
determine the message interaction state associated with the message based on the key identifier.

11. The system of claim 10, wherein to select the action state the at least one processor is further configured to:
identify a plurality of possible actions based on the current state and the message;
determine a priority for each of the possible actions based on the dynamic parameter; and
select the action based on the priority.

12. The system of claim 9, wherein to perform the action the at least one processor is further configured to:
transmit a second message to a destination identified in the message;

13. The system of claim 9, wherein to perform the action the at least one processor is further configured to:
transmit a dynamic information element to a plurality of destinations.

14. The system of claim 13, wherein to transmit the dynamic information element to a plurality of destinations the at least one processor is further configured to:
transmit a first value to a first destination; and
transmit a second value that is different than the first value to a second destination based on real-time changes associated with the dynamic information element.

15. The system of claim 9, the at least one processor further configured to:
transition the message interaction engine into a future state based on the message and the value of the dynamic parameter.

16. The system of claim 9, the at least one processor further configured to:
transition the message interaction engine into a future state of a plurality of future states based on the message and a dynamic transition prioritization rule for the current state,
wherein the dynamic transition prioritization rule comprises selection criteria for selecting a transition based on the value of the dynamic parameter, and
wherein the value of the dynamic parameter comprises a transition timer.

17. A tangible computer-readable device having instructions stored thereon that, when executed by at least one computing device, causes the at least one computing device to perform operations comprising:
receiving, by a message interaction device, a message;
determining a current state of a message interaction engine associated with the message;
determining a value of a dynamic parameter associated with the current state;
selecting an action based on the current state, the message, and the dynamic parameter;
performing the action; and
transitioning the message interaction engine into a future state based on the message and the value of the dynamic parameter.

18. The computer-readable device of claim 17, the determining of the current state comprising:
parsing the message to obtain a key identifier of the message interaction engine; and
determining the message interaction engine associated with the message based on the key identifier.

19. The computer-readable device of claim 18, the selecting of the action comprising:
identifying a plurality of possible actions based on the current state and the message;
determining a priority for each of the possible actions based on the dynamic parameter; and
selecting the action based on the priority.

20. The computer-readable device of claim 19, the performing of the action comprising:
transmitting a dynamic information element to a plurality of destinations.
